(19) United States
(12) Patent Application Publication
(10) Pub. No.: US 2024/0025421 A1
(43) Pub. Date: Jan. 25, 2024

(54) DRIVING OPERATION DETERMINER, DRIVING OPERATION DETERMINATION SYSTEM, DRIVING OPERATION DETERMINATION METHOD, AND MEMORY MEDIUM MEMORIZING PROGRAM

(71) Applicant: TOYOTA JIDOSHA KABUSHIKI KAISHA, Toyota-shi Aichi-ken (JP)

(72) Inventor: Ryoichi CHIBA, Toyota-shi Aichi-ken (JP)

(73) Assignee: TOYOTA JIDOSHA KABUSHIKI KAISHA, Toyota-shi Aichi-ken (JP)

(21) Appl. No.: 18/212,217

(22) Filed: Jun. 21, 2023

(30) Foreign Application Priority Data
Jul. 25, 2022 (JP) 2022-118302

(51) Int. Cl. B60W 40/10; B60Q 1/34

(52) U.S. Cl. CPC B60W 40/10; B60Q 1/34; B60W 2540/18; B60W 2520/14; B60W 2510/18; B60W 2556/45

(57) ABSTRACT

A driving operation determiner is configured to: based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and determine whether, within a predetermined set duration of time from a first time at which the first specific condition is satisfied, the turn signal lever is operated and a maximum value of a vehicle speed of the vehicle is a first threshold value or greater.

### CROSS-REFERENCE TO RELATED APPLICATION

This application is based on and claims priority under 35 USC 119 from Japanese Patent Application No. 2022-118302 filed on Jul. 25, 2022, the disclosure of which is incorporated by reference herein.

### BACKGROUND

### Technical Field

The present disclosure relates to a driving operation determiner, a driving operation determination system, a driving operation determination method, and a memory medium memorizing a program.

### Related Art

Japanese Patent Application Laid-Open (JP-A) No. 2005-284669 discloses a driving assessment for when a vehicle equipped with a turn signal lever turns right or left.

JP-A No. 2005-284669 has scope for improvement in regard to driving assessment relating to operation of a turn signal lever and a brake pedal when a vehicle turns right or left.

### SUMMARY

An aspect of the present disclosure is a driving operation determiner that includes: a memory; and a processor coupled to the memory, the processor being configured to: based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and determine whether, within a predetermined set duration of time from a first time at which the first specific condition is satisfied, the turn signal lever is operated and a maximum value of a vehicle speed of the vehicle is a first threshold value or greater.

### BRIEF DESCRIPTION OF DRAWINGS

FIG. 1 is a diagram illustrating a vehicle capable of transmitting detection values to a driving assessment device according to an exemplary embodiment.

FIG. 2 is a diagram illustrating a driving assessment system that is provided with the driving assessment device, the vehicle and a portable terminal.

FIG. 3 is an illustrative control block diagram of a first server of the driving assessment device shown in FIG. 2.

FIG. 4 is an illustrative control block diagram of a second server shown in FIG. 2.

FIG. 5 is a diagram illustrating a scene list.

FIG. 6 is a timing chart illustrating changes of position of a shift lever.

FIG. 7 is a schematic plan view illustrating a situation in which the vehicle turns left at an intersection.

FIG. 8 is a flowchart illustrating processing that is executed by the second server.

FIG. 9 is a flowchart illustrating processing that is executed by a fourth server.

FIG. 10 is a flowchart illustrating processing that is executed by the portable terminal shown in FIG. 2.

FIG. 11 is a diagram illustrating an image displayed at a display unit of the portable terminal.

### DETAILED DESCRIPTION

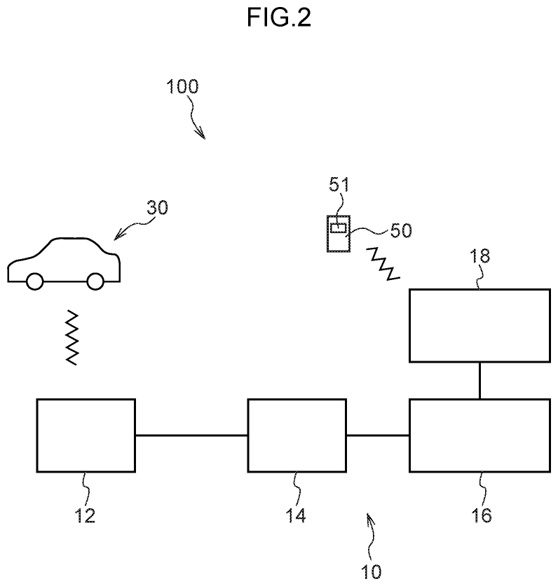

Below, an exemplary embodiment of a driving assessment device (a driving operation determiner) 10, a driving assessment system (a driving operation determination system) 100, a driving assessment method (a driving operation determination method) and a program according to the present disclosure is described with reference to the drawings. The driving assessment system 100 according to the present exemplary embodiment (below referred to as “the system 100”) is provided with the driving assessment device 10, a vehicle 30 and a portable terminal 50 that are capable of wireless communications with one another, as shown in FIG. 2.

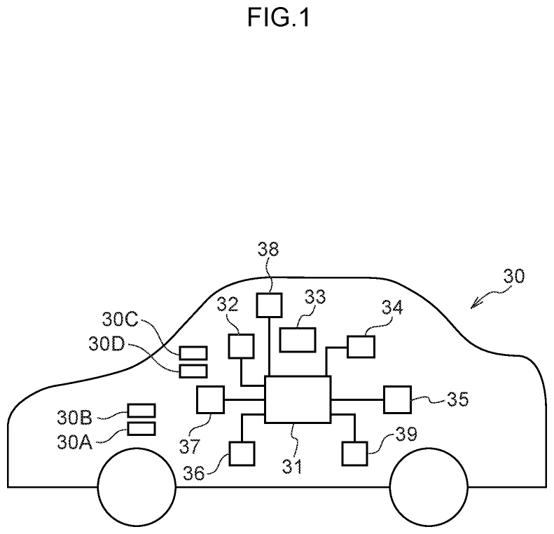

The vehicle 30 is capable of data communications with the driving assessment device 10 via a network. As shown in FIG. 1, the vehicle 30 includes an electronic control unit (ECU) 31, a vehicle speed sensor 32, a shift lever 33, a shift position sensor 34, a yaw rate sensor 35, a steering angle sensor 36, a turn signal switch (a lever position detection portion) 37, a brake switch (a brake operation detection portion) 38 and a Global Positioning System (GPS) receiver 39. A vehicle ID is assigned to the vehicle 30, which may be subject to assessment by the driving assessment device 10. The vehicle speed sensor 32, shift position sensor 34, yaw rate sensor 35, steering angle sensor 36, turn signal switch 37, brake switch 38 and GPS receiver 39 are connected to the ECU 31.

The ECU 31 includes a central processing unit (CPU), read-only memory (ROM), random access memory (RAM), storage, a communications interface (I/F), and an input/output interface. The CPU, ROM, RAM, storage, communications interface and input/output interface are connected with one another to be capable of communications via a bus. The CPU, ROM, RAM, storage, communications interface and input/output interface have similar structures and functions to, respectively, a CPU 12A, ROM 12B, RAM 12C, storage 12D, a communications interface 12E and an input/output interface 12F of a first server 12, which is described below. Details of these functions are described below. The network mentioned above encompasses communication networks of telecommunications carriers and internet networks. The vehicle 30, the first server 12 that is described below, a fourth server 18 and the portable terminal 50 perform data communications via this network.

As shown in FIG. 1, the vehicle 30 also includes an accelerator pedal 30A and a brake pedal 30B. When the accelerator pedal 30A is pressed by a foot of a driver of the vehicle 30, a drive source of the vehicle 30 is controlled by the ECU 31. The drive source of the vehicle 30 encompasses one or both of an internal combustion engine and an electric motor. When the brake pedal 30B is pressed by a foot of the driver, a braking apparatus of the vehicle 30 is controlled by the ECU 31.

The vehicle 30 further includes a steering wheel 30C. When the steering wheel 30C is operated by turning by a driver, a steering angle (and course angle) of the steering wheel 30C and steered wheels changes. A steering mechanism according to the present exemplary embodiment is not a steer-by-wire mechanism. The vehicle 30 also includes a turn signal lever (an indicator lever) 30D. The turn signal lever 30D is turnable from a predetermined neutral position (an initial position) to each of a first position at an upper side and a second position at a lower side.

The vehicle speed sensor 32 detects vehicle speeds of the vehicle 30. The shift lever 33 is movable to shift positions such as a D (drive) range (a forward running position), an R (reverse) range, a P (parking) range and an N (neutral) range. That is, the vehicle 30 is an automatic vehicle (AT vehicle). The shift position of the shift lever 33 is detected by the shift position sensor 34. As is widely known, when the shift lever 33 is at the D range, a gearing for forward running is formed. Therefore, when the shift lever 33 is at the D range, the vehicle 30 is capable of forward running under driving force of the drive source. When the shift lever 33 is at the R range, the vehicle 30 is capable of reverse running under driving force of the drive source.

The yaw rate sensor 35 detects yaw rates of the vehicle 30. In the present Description, the plus (+) symbol indicates magnitudes of yaw angles in the counterclockwise direction of the vehicle 30 in plan view, and the minus (−) symbol indicates magnitudes of yaw angles in the clockwise direction. The steering angle sensor 36 detects steering angles of the steering wheel 30C. In the present Description, the plus (+) symbol indicates magnitudes of steering angles when the steering wheel 30C is turned in the counterclockwise direction as seen by a driver, and the minus (−) symbol indicates magnitudes of steering angles when the steering wheel 30C is turned in the clockwise direction.

The turn signal switch 37 detects positions of the turn signal lever 30D. For example, when the turn signal switch 37 detects that the turn signal lever 30D is disposed at the first position, a left side direction indicator (a lighting device) provided at the vehicle 30 is illuminated under the control of the ECU 31. On the other hand, when the turn signal switch 37 detects that the turn signal lever 30D is disposed at the second position, a right side direction indicator (lighting device) provided at the vehicle 30 is illuminated under the control of the ECU 31.

When the brake pedal 30B is pressed by an operation amount that is at least a predetermined amount, the brake switch 38 goes into an on state and outputs predetermined detection signals. When the operation amount of the brake pedal 30B is less than the predetermined amount, the brake switch 38 goes into an off state. When the brake switch 38 outputs the detection signals, the braking apparatus operates under the control of the ECU 31 and a brake lamp is illuminated.

The GPS receiver 39 receives GPS signals transmitted from GPS satellites and thus acquires information relating to a position at which the vehicle 30 is running (below referred to as position information). Detection values from the vehicle speed sensor 32 (vehicle speed information), detection values from the shift position sensor 34, detection values from the yaw rate sensor 35 (yaw angle information), detection values from the steering angle sensor 36 (steering angle information), detection values from the turn signal switch 37 (lever operation information) and detection values from the brake switch 38 (brake operation information) are associated with time information representing times that is acquired from a timer provided at the ECU 31 and with the position information, and the detection values are transmitted to the ECU 31 via a Controller Area Network (CAN) provided in the vehicle 30 and are stored at the storage of the ECU 31.

As shown in FIG. 2, the driving assessment device 10 is provided with the first server 12, a second server 14, a third server 16 and the fourth server 18. As an example, the first server 12, the second server 14, the third server 16 and the fourth server 18 are disposed within a single building. The first server 12 and the fourth server 18 are connected to the aforementioned network. The first server 12 and the second server 14 are connected by a local area network (LAN), the second server 14 and the third server 16 are connected by the LAN, and the third server 16 and the fourth server 18 are connected by the LAN. In other words, the driving assessment device 10 is configured as a cloud computing system.

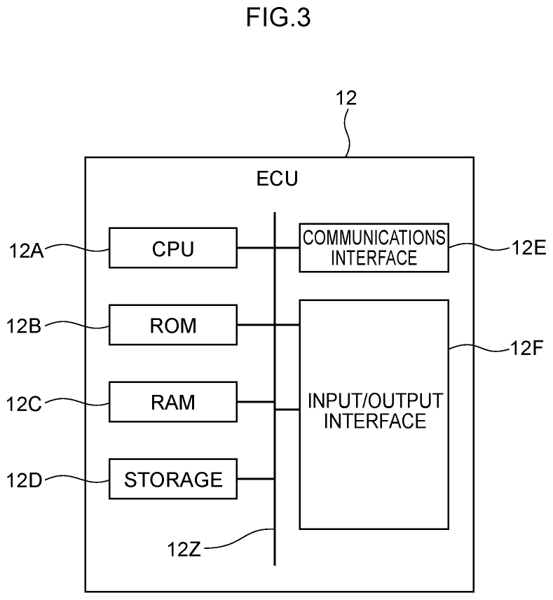

As shown in FIG. 3, the first server 12 includes the central processing unit (CPU, which is a hardware processor) 12A, the read-only memory (ROM) 12B, the random access memory (RAM) 12C, the storage 12D, which correspond to a memory, the communications interface (I/F) 12E, and the input/output interface 12F. The CPU 12A, ROM 12B, RAM 12C, storage 12D, communications interface 12E and input/output interface 12F are connected with one another to be capable of communications via a bus 12Z. The first server 12 is capable of acquiring information relating to dates and times from a timer.

The CPU 12A is a central arithmetic processing unit that executes various programs and controls respective parts. That is, the CPU 12A reads a program from the ROM 12B or storage 12D and executes the program, using the RAM 12C as a work area. The CPU 12A controls configurations and performs various kinds of computation processing (information processing) in accordance with programs recorded in the ROM 12B or storage 12D.

The ROM 12B stores various programs and various kinds of data. The RAM 12C serves as the work area and temporarily memorizes programs and data. The storage 12D is structured with a memory device such as a hard disk drive (HDD), a solid state drive (SSD) or the like, which is an example of a non-transitory memory medium. The storage 12D stores various programs and various kinds of data. The communications interface 12E is an interface for the first server 12 to communicate with other equipment. The communications interface 12E is capable of, for example, wireless communications with the vehicle 30 and the portable terminal 50. The input/output interface 12F is an interface for communicating with various devices.

Data representing detection values detected by the vehicle speed sensor 32, the shift position sensor 34, the yaw rate sensor 35, the steering angle sensor 36, the turn signal switch 37, the brake switch 38 and the GPS receiver 39 is referred to as detection value data. Between a start button provided at an instrument panel of the vehicle 30 being switched to an on state and the start button being switched to an off state, each time a predetermined duration passes, the detection value data is transmitted from the communications interface of the ECU 31 to the communications interface 12E of the first server 12 via the aforementioned network, and the detection value data is recorded at the storage 12D. When the start button is in the on state, the aforementioned drive source is in an operable state and the vehicle 30 is in a state capable of running. All of the detection value data recorded at the storage 12D includes information relating to the vehicle ID, time information and position information.

Basic structures of the second server 14, the third server 16 and the fourth server 18 are the same as the first server 12.

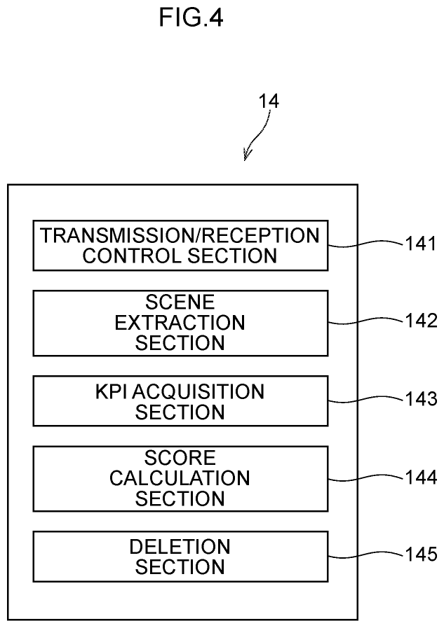

FIG. 4 is a block diagram showing an example of functional structures of the second server (a computer) 14. As functional structures, the second server 14 includes a transmission/reception control section 141, a scene extraction section 142, a KPI acquisition section 143, a score calculation section 144 and a deletion section 145. The transmission/reception control section 141, scene extraction section 142, KPI acquisition section 143, score calculation section 144 and deletion section 145 are realized by the CPU of the second server 14 reading and executing a program memorized in ROM.

The transmission/reception control section 141 controls the communications interface of the second server 14. The communications interface of the second server 14 receives information from the communications interfaces of the first server 12 and the third server 16 via the LAN. The detection value data recorded at the storage 12D of the first server 12 is associated with the vehicle ID, time information and place information when being transmitted to the communications interface of the second server 14. The detection value data transmitted from the first server 12 to the second server 14 includes a data set acquired during a predetermined data detection duration. This data detection duration is, for example, 30 minutes. Below, a data set that corresponds with a single vehicle ID and is acquired in the data detection duration is referred to as a detection value data set. Detection value data sets recorded at the first server 12 are sequentially transmitted to the communications interface of the second server 14 in order from the oldest time of acquisition. More specifically, when a detection value data set has been deleted from the storage of the second server 14 as described below, a detection value data set that is newer than that detection value data set is transmitted from the first server 12 to the second server 14, and the newer detection value data set is stored at the storage of the second server 14.

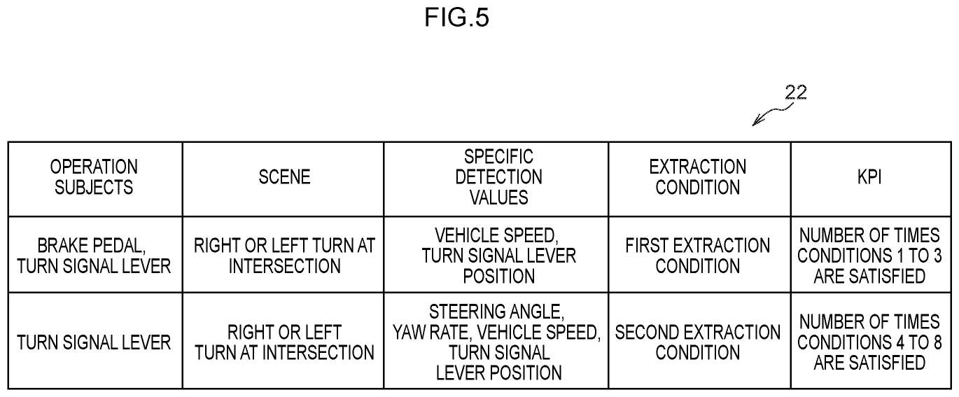

FIG. 5 shows a scene list 22, which is recorded at the ROM of the second server 14. The scene list 22 is defined in accordance with details of operations of various operation members of the vehicle 30.

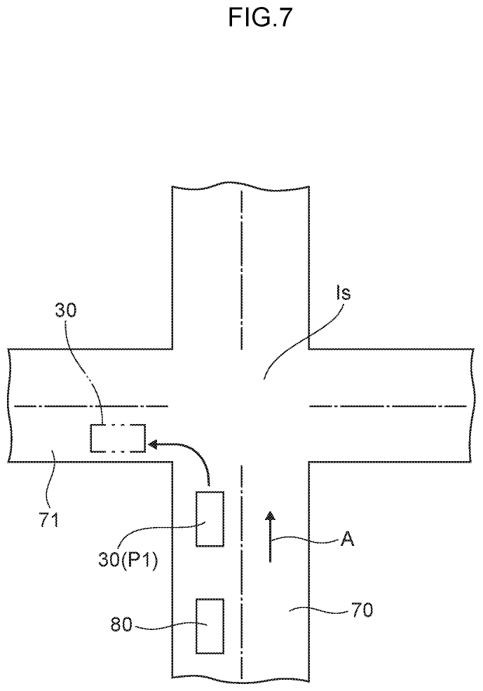

Operation subjects relating to a first extraction condition included in the scene list 22 are the brake pedal 30B and the turn signal lever 30D. A scene relating to the first extraction condition is a right or left turn of the vehicle at an intersection. FIG. 7 shows a situation in which the vehicle 30 runs forward along a road 70 in the direction of arrow A, turns left at an intersection Is, and enters a road 71. The first extraction condition relates to, for example, the scene shown in FIG. 7.

On the basis of detection values from the shift position sensor 34, the turn signal switch 37 and the brake switch 38, the scene extraction section 142 makes a determination as to whether all of the following conditions A, B and C are fulfilled. When the scene extraction section 142 determines that all of conditions A, B and C are fulfilled, a scene start condition (a first specific condition) relating to the first extraction condition is satisfied.

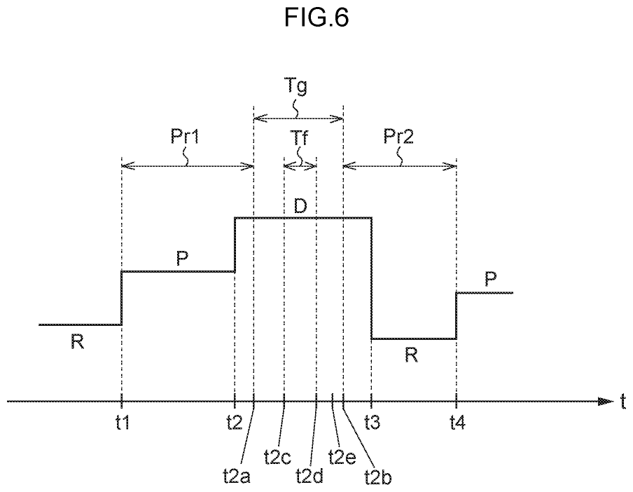

Condition A: The shift lever 33 is disposed at the D range. The timing chart in FIG. 6 shows a situation in which the shift lever 33 is moved from a specified position that is a shift position other than the D range (such as the P range, R range or N range) to the D range, and is subsequently moved from the D range to a specified position. For convenience, the shift position directly before the shift lever 33 is moved to the D range is referred to as a first specified position and the shift position after the shift lever 33 is moved from the D range is referred to as a second specified position. In the example in FIG. 6, the P range is the first specified position and the R range is the second specified position. At a time t1 (a third time), the shift lever 33 is moved from the R range to the P range (the first specified position). At a time t2, the shift lever 33 is moved from the P range to the D range, and at a time t3, the shift lever 33 is moved from the D range to the R range (the second specified position). At a time t4 (a sixth time), the shift lever 33 is moved from the R range to the P range. A time that is a first exclusion period Pr1 (a first predetermined duration) after time t1 is a time t2a (a fourth time), and a time that is a second exclusion period Pr2 (a second predetermined duration) before time t4 is a time t2b (a fifth time). The first exclusion period Pr1 and the second exclusion period Pr2 are, for example, 60 s. A duration between time t2a and time t2b is an object duration Tg. Time t2a and time t2b are not included in the object duration Tg. That is, a time period preceding and including time t2a and a time period succeeding and including time t2b are not in the object duration Tg.

Condition B: The brake switch 38 is switched from the Off state to the On state. Condition C: The turn signal lever 30D is at the neutral position (the initial position).

The scene start condition is satisfied at a time t2c (a first time). A time t2d (a second time) is a time when a predetermined set duration Tf has passed after time t2c and that is included in the object duration Tg. At time t2d, a scene end condition is satisfied. The set duration Tf is, for example, 1.5 s. It is required that all of the conditions A, B and C be fulfilled between time t2c and time t2d.

The scene extraction section 142 distinguishes between data representing specific detection values and other data in a detection value data set stored at the storage. More specifically, the scene extraction section 142 extracts data detected by the vehicle speed sensor 32 and the turn signal switch 37 in the set duration Tf to be specific detection values, which are data required for acquisition of a key performance indicator (KPI), which is described below.

On the basis of these specific detection values, the KPI acquisition section 143 acquires (calculates) a KPI corresponding to the first extraction condition.

On the basis of the specific detection values extracted by the scene extraction section 142, which are detection values from the vehicle speed sensor 32 and the turn signal switch 37, the KPI acquisition section 143 makes a determination as to whether all of the following conditions 1 to 3, which are included in the first extraction condition, are satisfied. In this description, a situation is anticipated in which the vehicle 30 passes through position P1 in FIG. 7 while running forward at a significant speed and subsequently turns left at the intersection Is. When the vehicle 30 has reached position P1, the vehicle speed is greatly reduced by pressing of the brake pedal 30B but the turn signal lever 30D is disposed at the neutral position. In this situation, all of conditions 1 to 3 are satisfied. That is, the first extraction condition is satisfied in this situation. In a situation in which the first extraction condition is satisfied, there is a high probability that a driver of a following vehicle 80 that is running forward in the direction of arrow A behind the vehicle 30 will feel concern. Accordingly, as described below, a score relating to the KPI for a situation in which all of conditions 1 to 3 are satisfied is low.

Condition 1: A maximum value Vmax1 of the vehicle speed in the set duration Tf is a first threshold value or greater. The first threshold value is, for example, 15 km/h. Thus, condition 1 is satisfied when the vehicle 30 is running at a significant speed.

Condition 2: A vehicle speed V1 at time t2c (the first time) is at least a second threshold value higher than a vehicle speed V2 at time t2d (the second time). The second threshold value is, for example, 10 km/h. Thus, the second condition is satisfied when a braking force is generated that greatly reduces the vehicle speed of the vehicle 30 in a short duration.

Condition 3: The turn signal lever 30D is disposed at the first position or the second position.

As shown in FIG. 5, the scene list 22 includes a second extraction condition that is different from the first extraction condition. An operation subject relating to the second extraction condition is the turn signal lever 30D. A scene relating to the second extraction condition is a right or left turn of the vehicle at an intersection. The second extraction condition relates to, for example, the scene shown in FIG. 7.

On the basis of the detection values from the vehicle speed sensor 32, the shift position sensor 34, the steering angle sensor 36 and the turn signal switch 37, the scene extraction section 142 makes a determination as to whether all of the above conditions A and C and the following conditions D and E are fulfilled. When the scene extraction section 142 determines that all of conditions A, C, D and E are fulfilled, a scene start condition (a second specific condition) relating to the second extraction condition is satisfied.

Condition D: The absolute value of a steering angle θs of the steering wheel 30C is a third threshold value or greater. The third threshold value is, for example, 30°.

Condition E: The vehicle speed is a fourth threshold value or greater. The fourth threshold value is, for example, 5 km/h.

In this description, a situation is anticipated in which the scene start condition relating to the second extraction condition is satisfied at time t2c in FIG. 7. Moreover, a situation is anticipated in which at least one of the conditions A, C, D and E is satisfied at time t2e, which is included in the object duration Tg of FIG. 6. When not even one of the conditions A, C, D and E is fulfilled, a scene end condition relating to the second extraction condition is satisfied.

The scene extraction section 142 extracts data detected by the vehicle speed sensor 32, the yaw rate sensor 35, the steering angle sensor 36 and the turn signal switch 37 between time t2c and time t2e from the detection value data set stored at the storage to be the data representing specific detection values.

The KPI acquisition section 143 acquires a KPI corresponding to the second extraction condition on the basis of these specific detection values. On the basis of the specific detection values extracted by the scene extraction section 142, which are detection values from the vehicle speed sensor 32, the yaw rate sensor 35, the steering angle sensor 36 and the turn signal switch 37, the KPI acquisition section 143 makes a determination as to whether all of the following conditions 4 to 8, which are included in the second extraction condition, are satisfied. For example, all of conditions 4 to 8 are satisfied in a situation in which the vehicle 30 turns left at the intersection Is in FIG. 7 while running forward at a significant speed but the turn signal lever 30D is disposed at the neutral position. That is, the second extraction condition is satisfied in this situation. In a situation in which the second extraction condition is satisfied, there is a high probability of a driver of the following vehicle 80 and pedestrians crossing the intersection Is feeling concern. Accordingly, as described below, a score relating to the KPI for a situation in which all of conditions 4 to 8 are satisfied is low.

Condition 4: The absolute value of a yaw angle θy of the vehicle 30 is at least a fifth threshold value and at most a sixth threshold value. For example, the fifth threshold value is and the sixth threshold value is 120°. The KPI acquisition section 143 integrates yaw rates detected by the yaw rate sensor 35 to acquire the yaw angle θy.

Condition 5: The absolute value of a maximum value Stmax of the steering angle θs of the steering wheel 30C is at least a seventh threshold value and at most an eighth threshold value. For example, the seventh threshold value is 75° and the eighth threshold value is 450°.

Condition 6: A duration from the time the scene start condition is satisfied (t2c) until the time the scene end condition is satisfied (t2e) is a ninth threshold value or greater. The ninth threshold value is, for example, 4.0 s. The KPI acquisition section 143 determines condition 6 on the basis of time information included with the detection values from the vehicle speed sensor 32, the yaw rate sensor 35, the steering angle sensor 36 and the turn signal switch 37.

Condition 7: A maximum value Vmax2 of the vehicle speed is a tenth threshold value or greater. The tenth threshold value is, for example, 20 km/h.

Condition 8: The turn signal lever 30D is disposed at the neutral position.

Although not shown in the drawings, extraction conditions that are different from the first and second extraction conditions can be included in the scene list 22. These extraction conditions relate to scenes, specific detection values and KPIs in relation to, for example, the accelerator pedal 30A and the brake pedal 30B. Detailed descriptions relating to these extraction conditions are not given here.

The score calculation section 144 calculates a driving operation score on the basis of calculated KPIs, as described below.

When the scene extraction section 142, the KPI acquisition section 143 and the score calculation section 144 complete the processing described above for one detection value data set recorded at the storage, the communications interface of the second server 14 transmits data relating to the acquired driving operation score together with information relating to the vehicle ID to the communications interface of the third server 16.

When the scene extraction section 142, the KPI acquisition section 143 and the score calculation section 144 complete the processing described above for the one detection value data set, the deletion section 145 deletes that detection value data set from the storage of the second server 14.

The communications interface of the third server 16 receives the data relating to the driving operation score that is transmitted from the second server 14. The data received by the communications interface of the third server 16 is recorded at the storage of the third server 16.

The fourth server 18 functions at least as a web server and a web app server. The communications interface of the fourth server 18 receives data transmitted from the communications interface of the third server 16 and records the received data at the storage of the fourth server 18.

The portable terminal 50 shown in FIG. 2 includes a CPU, ROM, RAM, storage, a communications interface and an input/output interface. The portable terminal 50 is, for example, a smartphone or a tablet-type computer. The CPU, ROM, RAM, storage, communications interface and input/output interface of the portable terminal 50 are connected with one another to be capable of communications via a bus. The portable terminal 50 is provided with a display unit 51 including a touch panel. The display unit 51 is connected to the input/output interface of the portable terminal 50. The display unit 51 may be, for example, a liquid crystal display, an organic electroluminescent display or the like.

The portable terminal 50 is carried by, for example, a driver of the vehicle 30 to which the vehicle ID is assigned. A predetermined driving assessment display application is installed at the portable terminal 50. The communications interface of the portable terminal 50 is capable of conducting wireless communications with the communications interface of the fourth server 18. That is, the communications interface of the portable terminal 50 is capable of transmitting and receiving data to and from the communications interface of the fourth server 18. Under the control of the CPU, the display unit 51 displays, for example, information that the communications interface of the portable terminal 50 receives from the communications interface of the fourth server 18 and information entered via the touch panel. The communications interface of the portable terminal 50 may transmit information entered by the touch panel to the communications interface of the fourth server 18.

Operation and Effects

Now, operation and effects of the present exemplary embodiment are described.

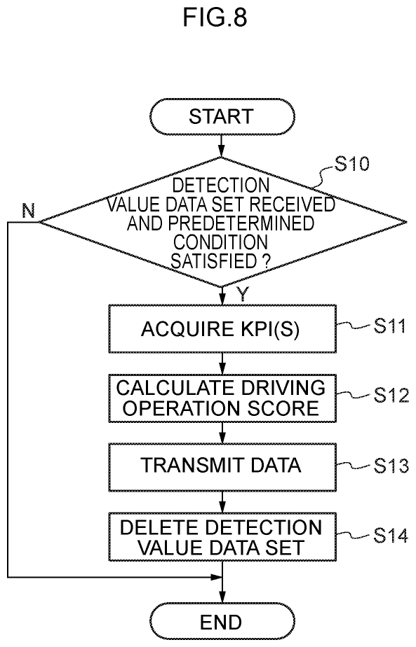

First, a flow of processing that is carried out by the CPU of the second server 14 (below referred to as “the second CPU”) is described using the flowchart of FIG. 8. While the start button is in the on state, the second CPU executes the processing of the flowchart in FIG. 8 repeatedly, each time a predetermined duration passes.

In step S10 (the word “step” is omitted in the descriptions below), the second CPU of the second server 14 makes a determination as to whether the communications interface has received a detection value data set from the first server 12. That is, the second CPU makes a determination as to whether a detection value data set is recorded at the storage of the second server 14. The second CPU also makes a determination as to whether a predetermined condition is satisfied. Examples of this predetermined condition include the scene end conditions mentioned above.

When the result of the determination in S10 is Yes, the second CPU proceeds to S11, and the scene extraction section 142 extracts data representing specific detection values from the detection value data set saved at the storage. Then, the KPI acquisition section 143 acquires (calculates) KPIs on the basis of the extracted data representing the specific detection values.

For example, when the first extraction condition is satisfied, the KPI acquisition section 143 acquires a number of times that the first extraction condition is satisfied while the start button is in the on state as a KPI.

Further, when the second extraction condition is satisfied, the KPI acquisition section 143 acquires a number of times that the second extraction condition is satisfied while the start button is in the on state as a KPI.

When the processing of S11 is complete, the second CPU proceeds to S12 and the score calculation section 144 calculates a driving operation score.

For example, when the number of times the first extraction condition has been satisfied is one or more, the score calculation section 144 sets a score relating to the first extraction condition to 1 point. On the other hand, when the number of times the first extraction condition has been satisfied is zero, the score calculation section 144 sets the score relating to the first extraction condition to 100 points.

Further, when the number of times the second extraction condition has been satisfied is one or more, the score calculation section 144 sets a score relating to the second extraction condition to 1 point. On the other hand, when the number of times the second extraction condition has been satisfied is zero, the score calculation section 144 sets the score relating to the second extraction condition to 100 points.

When an extraction condition other than the first and second extraction conditions is satisfied, the score calculation section 144 calculates a score according to a KPI of the corresponding operation subjects.

The score calculation section 144 calculates the driving operation score on the basis of the calculated scores. More specifically, the score calculation section 144 acquires a value (an average value) for which a total of the scores corresponding to the respective extraction conditions is divided by the number of extraction conditions (for example, three) to serve as the driving operation score.

When the processing of S12 is complete, the second CPU proceeds to S13 and the communications interface transmits data relating to the driving operation score together with information relating to the vehicle ID to the third server 16.

When the processing of S13 is complete, the second CPU proceeds to S14 and the deletion section 145 deletes this detection value data set from the storage of the second server 14.

When the result of the determination in S10 is No or the processing of S14 is complete, the second CPU temporarily ends the processing of the flowchart of FIG. 8.

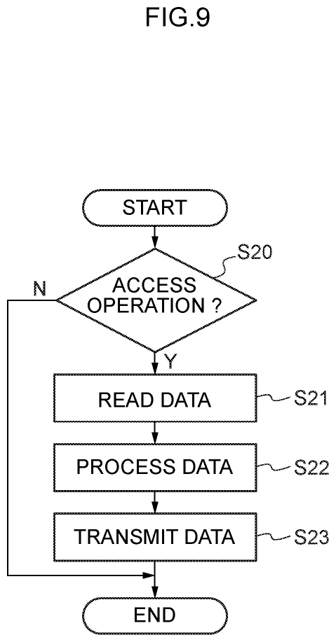

Now, a flow of processing that is carried out by the CPU of the fourth server 18 (below referred to as “the fourth CPU”) is described using the flowchart of FIG. 9. The fourth CPU executes the processing of the flowchart in FIG. 9 repeatedly, each time a predetermined duration passes.

In S20, the fourth CPU of the fourth server 18 makes a determination as to whether a display request has been transmitted to the communications interface of the fourth server 18 from the communications interface of the portable terminal 50, which is running the driving assessment display application. That is, the fourth CPU makes a determination as to whether there is an access operation from the portable terminal 50. This display request includes information relating to a vehicle ID associated with the portable terminal 50.

When the result of the determination in S20 is Yes, the fourth CPU proceeds to S21 and the communications interface of the fourth server 18 conducts communications with the third server 16. From the communications interface of the third server 16, the communications interface of the fourth server 18 receives data relating to a driving operation score corresponding with the vehicle ID that is associated with the portable terminal 50 transmitting the display request.

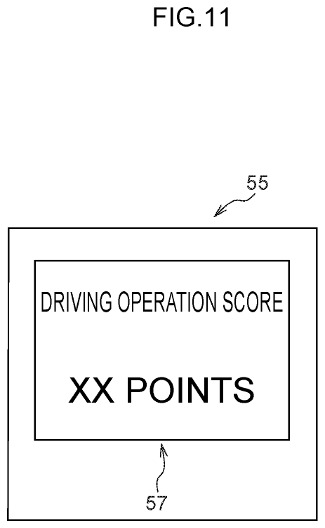

When the processing of S21 ends, the fourth CPU proceeds to S22 and uses the data received in S21 to generate data representing a driving assessment results image 55 (see FIG. 11). The driving assessment results image 55 may be displayed by the display unit 51 of the portable terminal 50 running the driving assessment display application.

When the processing of S22 ends, the fourth CPU proceeds to S23 and the communications interface of the fourth server 18 transmits the data generated in S22 to the communications interface of the portable terminal 50.

When the result of the determination in S20 is No or the processing of S23 is complete, the fourth CPU temporarily ends the processing of the flowchart of FIG. 9.

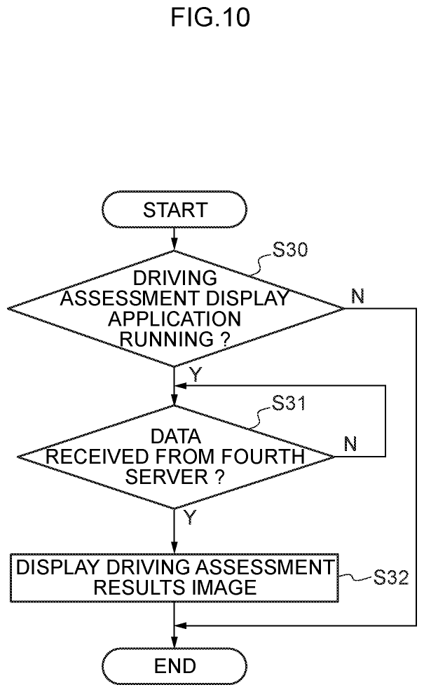

Now, a flow of processing that is carried out by the CPU of the portable terminal (below referred to as “the terminal CPU”) is described using the flowchart of FIG. 10. The terminal CPU executes the processing of the flowchart in FIG. 10 repeatedly, each time a predetermined duration passes.

In S30, the terminal CPU makes a determination as to whether the driving assessment display application is running.

When the result of the determination in S30 is Yes, the terminal CPU proceeds to S31 and makes a determination as to whether the communications interface of the portable terminal 50 has received data representing the driving assessment results image 55 from the communications interface of the fourth server 18.

When the result of the determination in S31 is Yes, the terminal CPU proceeds to S32 and displays the driving assessment results image 55 at the display unit 51.

As shown in FIG. 11, the driving assessment results image 55 includes a score display portion 57. The driving operation score is displayed in the score display portion 57.

When the result of the determination in S30 is No or the processing of S32 is complete, the terminal CPU temporarily ends the processing of the flowchart of FIG. 10.

As described above, the second server 14 according to the present exemplary embodiment makes a determination as to whether the turn signal lever 30D is moved to the first position or the second position and the maximum value Vmax1 of the vehicle speed is at least the first threshold value within the set duration Tf after the time t2c (the first time), at which time t2c it is determined that the shift lever 33 is in the D range, the brake pedal 30B of the vehicle 30 changes from the unpressed state to the pressed state, and the turn signal lever is disposed at the neutral position. That is, the second server 14 determines whether or not the brake pedal 30B of the vehicle that is running forward at a significant speed is pressed before the turn signal lever 30D is moved to the first position or second position. In a situation in which the brake pedal 30B of the vehicle 30 that is turning right or left while running forward at a significant speed is pressed before the turn signal lever 30D is operated, there is a high probability of a driver of the following vehicle 80 feeling concern. Therefore, the second server 14 may accurately determine whether or not operations of the turn signal lever 30D and brake pedal 30B of the vehicle 30 that turns right or left while running forward are operations with a risk of causing concern to the driver of the following vehicle 80.

A situation is anticipated in which the vehicle 30 that is intended to turn right or left at an intersection is stopped just before the intersection by pressing of the brake pedal and the turn signal lever 30D that has been disposed at the first position or second position unintendedly returns to the neutral position while the vehicle 30 is stopped. In this situation, because the second server 14 makes the determination including whether or not the maximum speed Vmax1 is at least the first threshold value, the second server 14 does not erroneously determine that “the brake pedal 30B of the vehicle 30 . . . running forward at a significant speed is pressed before the turn signal lever 30D is operated”.

The second server 14 further makes a determination as to whether the vehicle speed V1 of the vehicle 30 at time t2c (the first time) is higher by at least the second threshold value than the vehicle speed V2 at time t2d (the second time), which is the end time of the set duration Tf. That is, the second server 14 determines whether a brake operation that greatly reduces the speed of the vehicle 30 is conducted within the set duration Tf. When the turn signal lever 30D of the vehicle 30 is at the neutral position, the left and right direction indicators of the vehicle 30 are not illuminated. Therefore, there is a high probability of a driver of the following vehicle 80 expecting that the vehicle 30 will progress forward when passing through the intersection Is. In this situation, if a brake operation that greatly reduces the speed of the vehicle 30 is conducted, the driver of the following vehicle 80 is likely to feel great concern. Therefore, the second server 14 may accurately determine whether or not operations of the turn signal lever 30D and brake pedal 30B of the vehicle 30 that turns right or left while running forward are operations with a risk of causing concern to the driver of the following vehicle 80.

A situation is anticipated in which, because a red lamp (a stop light) of a signal provided at the intersection Is in FIG. 7 is illuminated, the brake pedal 30B of the vehicle 30 running along the road 70 is pressed and the vehicle 30 stops just before the intersection Is. It is anticipated that the turn signal lever 30D is then moved from the neutral position to the first position or second position while the vehicle 30 is stopped but after the set duration Tf has passed from the time at which the brake pedal 30B was pressed. Below, this situation is referred to as a first specific situation. In this first specific situation, the turn signal lever is moved from the neutral position to the first position or second position after the set duration Tf has passed. Therefore, when the first specific situation occurs, the second server 14 does not erroneously determine that “the brake pedal 30B of the vehicle 30 . . . running forward at a significant speed is pressed before the turn signal lever 30D is operated”. When the first specific situation occurs, there is little risk of a driver of the following vehicle 80 that is stopped just behind the vehicle 30 feeling concern due to the behavior of the vehicle 30. Therefore, the above-described erroneous determination would not be desirable.

A situation is anticipated in which the vehicle 30 is stopped on the road 70 at the intersection Is in order to perform a right turn or left turn, or the vehicle 30 is stopped on a road in order to perform a U-turn. It is then anticipated that the turn signal lever 30D that has been disposed at the first position or second position unintendedly moves to the neutral position while the vehicle 30 is stopped, and that the turn signal lever 30D is returned to the first position or second position before the vehicle 30 starts to move. Below, this situation is referred to as a second specific situation. When this second specific situation occurs, there is a high probability that the speed of the vehicle 30 is zero until the set duration Tf passes from the time at which the turn signal lever 30D moves to the neutral position. However, because the second server 14 makes the determination including whether or not the maximum value Vmax1 of the vehicle speed in the set duration Tf is at least the first threshold value, when the second specific situation occurs, there is a high probability that the second server 14 will not erroneously determine that “the brake pedal 30B of the vehicle 30 . . . running forward at a significant speed is pressed before the turn signal lever 30D is operated”. When the second specific situation occurs, there is little risk of a driver of the following vehicle 80 that is stopped just behind the vehicle 30 feeling concern due to the behavior of the vehicle 30. Therefore, the above-described erroneous determination would not be desirable.

The second server 14 makes a further determination as to whether the shift lever 33 is in the D range, the absolute value of the steering angle θs is at least the third threshold value, the turn signal lever 30D is disposed at the neutral position, and the speed of the vehicle 30 is at least the fourth threshold value. That is, the second server 14 determines whether or not the vehicle 30 that is running forward at a significant speed and in which the turn signal lever 30D is disposed at the neutral position steers to the left or to the right. In a situation in which this condition is satisfied, the second server 14 makes a determination as to whether the absolute value of the yaw angle θy of the vehicle 30 is at least the fifth threshold value and at most the sixth threshold value and whether the absolute value of a maximum value of the steering angle θs is at least the seventh threshold value and at most the eighth threshold value. That is, the second server 14 makes a determination as to whether the vehicle 30 in which the turn signal lever 30D is disposed at the neutral position turns left or right at an intersection.

A situation is anticipated in which the vehicle 30 is trying to perform a U-turn. In this situation, the absolute value of the yaw angle θy of the vehicle 30 is greater than the sixth threshold value and the absolute value of the maximum value of the steering angle θs is greater than the eighth threshold value. Therefore, in this situation the second server 14 does not erroneously determine that “the vehicle 30 in which the turn signal lever 30D is disposed at the neutral position turns left or right at an intersection”.

The second server 14 makes a further determination as to whether a duration from the time (t2c) when the scene start condition relating to the second extraction condition is satisfied to the time (t2e) when the scene end condition is satisfied is at least the ninth threshold value and a maximum value Vmax2 of the vehicle speed is at most the tenth threshold value. In a situation in which the scene start condition (of the second specific condition) is satisfied while the vehicle 30 is running along a road that is curved over a long distance in a longitudinal direction, there is a high probability of the duration from the time the scene start condition is satisfied until the time the scene end condition is satisfied being less than the ninth threshold value (for example, less than 4.0 s). In addition, there is a high probability of the maximum value Vmax2 of the vehicle speed of the vehicle 30 in this situation being greater than the tenth threshold value (for example, 20 km/h). Therefore, when the turn signal lever 30D of the vehicle 30 that is running along this kind of curved road is disposed at the neutral position, there is little likelihood of the second server 14 erroneously determining that “the vehicle 30 in which the turn signal lever 30D is disposed at the neutral position turns left or right at an intersection Is”. Therefore, the second server 14 may accurately determine whether or not the vehicle 30 in which the turn signal lever 30D is disposed at the neutral position turns left or right at the intersection Is.

A situation is anticipated in which the scene start condition relating to the first extraction condition (the first specific condition) is determined to be satisfied in a time period between time t2 and time t2a in FIG. 6 or a time period between time t2b and and time t3. In this situation, if conditions 1 to 3 are satisfied, the second server 14 in effect determines that “the brake pedal 30B of the vehicle 30 that is intended to turn left or right at an intersection while running forward at a significant speed is pressed before the turn signal lever 30D is operated”. However, time t2 is the time at which the shift lever 33 is switched from the P range to the D range, and time t3 is the time at which the shift lever 33 is switched from the D range to the R range. Generally, there is a low probability of the shift lever 33 being disposed at a shift position (a specified position) other than the D range just before or just after the vehicle 30 running forward turns left or right at an intersection. That is, when the vehicle 30 is entering or leaving a parking space, the shift lever 33 is likely to be frequently moved between the D range and a specified position. Therefore, when the scene start condition is satisfied in the time period between time t2 and time t2a in FIG. 6, irrespective of the vehicle 30 actually performing movements for entering or leaving a parking space, there is a risk of the second server 14 erroneously determining that “the brake pedal 30B of the vehicle 30 that is intended to turn left or right at an intersection while running forward at a significant speed is pressed before the turn signal lever 30D is operated”. However, because the second server 14 determines that the scene start condition is not satisfied when condition A is not fulfilled, there is little likelihood of the second server 14 producing this erroneous determination.

Similarly, a situation is anticipated in which the scene start condition relating to the second extraction condition (the second specific condition) is determined to be satisfied in the time period between time t2 and t2a in FIG. 6 or the time period between time t2b and and time t3. In this situation, if conditions 4 to 8 are satisfied, the second server 14 in effect determines that “the vehicle 30 in which the turn signal lever 30D is disposed at the neutral position is conducting a left turn or right turn”. However, because the second server 14 according to the present exemplary embodiment determines that the scene start condition is not satisfied when condition A is not fulfilled, there is little likelihood of the second server 14 producing this erroneous determination.

In the present exemplary embodiment, driving assessment is carried out using driving operation scores (KPIs). Therefore, a driver viewing the driving assessment results image 55 may easily understand characteristics of their own driving operations.

The KPI acquisition section 143 uses only specific detection values in a detection value data set to calculate a KPI. Therefore, a computation load on the KPI acquisition section 143 is smaller than if the KPI were calculated using all of the detection value data set. Thus, a computation load of the driving assessment device 10 is smaller.

Above, the driving assessment device 10, system 100, driving assessment method and program according to the exemplary embodiment are described, but the designs thereof may be modified as appropriate within a scope not departing from the gist of the present disclosure.

The driving assessment results image 55 may include time information representing times at which behaviors of the vehicle 30 that are targets of driving assessment occurred and position information representing places at which these behaviors occurred. The driving assessment results image 55 may also include map data, and the map data may include information representing the times and places at which these behaviors occurred. Accordingly, the driver seeing the driving assessment results image 55 displayed at the display unit 51 may recognize the times and places at which they conducted the driving operations relating to these behaviors.

One or more of conditions 1 to 3 may be omitted. Similarly, one or more of conditions 4 to 8 may be omitted.

The driving assessment device 10 may be embodied with a configuration different from that described above. For example, the first server 12, the second server 14, the third server 16 and the fourth server 18 may be embodied by a single server. In this configuration, for example, a hypervisor may be employed and the interior of this server may be virtually divided into regions respectively corresponding to the first server 12, the second server 14, the third server 16 and the fourth server 18.

The driving assessment device 10 need not be connected to the Internet, in which case, for example, detection value data sets acquired from the vehicle are recorded on a portable recording medium (for example, a USB Flash drive) and the detection value data sets in the recording medium are copied to the first server 12.

In place of the GPS receiver 39, the vehicle 30 may be equipped with a receiver that is capable of receiving information from satellites of a global navigation satellite system other than GPS (for example, GALILEO).

The ECU 31 of the vehicle 30 may feature functions corresponding to the scene extraction section 142, the KPI acquisition section 143 and the score calculation section 144.

### Additional Remarks

A driving assessment device of the present disclosure may be an arbitrary combination of the following configurations 1 to 6.

<Configuration 1> A driving operation determiner that: on the basis of brake operation information representing whether or not a brake pedal of a vehicle is pressed, lever operation information representing whether or not a turn signal lever of the vehicle is operated, and vehicle speed information of the vehicle, makes a determination as to whether a first specific condition is satisfied, the first specific condition being satisfied when, in a state in which the vehicle is capable of forward running, the brake pedal of the vehicle changes from an unpressed state to a pressed state and the turn signal lever is not operated; and makes a determination as to whether, within a predetermined set duration from a first time at which the first specific condition is satisfied, the turn signal lever is operated and a maximum value of the vehicle speed of the vehicle is at least a first threshold value.

<Configuration 2> A driving operation determiner that makes a determination as to whether the vehicle speed at the first time is higher by at least a second threshold value than the vehicle speed at a second time, the second time being an end time of the set duration.

<Configuration 3> A driving assessment device that, when a shift position of a shift lever of the vehicle changes from a first specified position to a forward running position at which a gearing for forward running is formed, the first specified position being any of a P range, an R range and an N range, and the shift lever moving to the first specified position at a third time, excludes a time period preceding a fourth time from the set duration, the fourth time being a first predetermined duration after the third time.

<Configuration 4> A driving assessment device that, when a shift position of a shift lever of the vehicle changes from a forward running position at which a gearing for forward running is formed to a second specified position that is any of a P range, an R range and an N range and the shift position subsequently changes from the second specified position to a different shift position, the shift lever moving to the different shift position at a sixth time, excludes a time period succeeding a fifth time from the set duration, the fifth time being a second predetermined duration before the sixth time.

<Configuration 5> A driving assessment device that: on the basis of steering angle information representing a steering angle of a steering wheel of the vehicle, the lever operation information, and the vehicle speed information, makes a determination as to whether a second specific condition is satisfied in the state in which the vehicle is capable of forward running, the second specific condition being satisfied when the absolute value of the steering angle of the vehicle is at least a third threshold value, the turn signal lever is not operated, and the vehicle speed is at least a fourth threshold value; and, on the basis of yaw angle information representing a yaw angle of the vehicle and the steering angle information while the second specific condition is satisfied, makes a determination as to whether the absolute value of the yaw angle is at least a fifth threshold value and at most a sixth threshold value and the absolute value of a maximum value of the steering angle is at least a seventh threshold value and at most an eighth threshold value.

<Configuration 6> A driving assessment device that makes a determination as to whether a duration for which the second specific condition is satisfied continuously is at least a ninth threshold value and a maximum value of the vehicle speed while the second specific condition is satisfied is at most a tenth threshold value.

A driving assessment system of the present disclosure may be a combination of configuration 7 described below and one or more of configurations 1 to 6.

<Configuration 7> A driving operation determination system including: the driving operation determiner; a brake operation detection portion that acquires the brake operation information; a lever position detection portion that acquires the lever operation information; and a vehicle speed sensor that acquires the vehicle speed information.

A driving assessment method of the present disclosure may be a combination of configuration 8 described below and one or more of configurations 1 to 7.

<Configuration 8> A driving assessment method including a step of, for a predetermined set duration from a first time at which it is determined, on the basis of brake operation information representing whether or not a brake pedal of a vehicle is pressed, lever operation information representing whether or not a turn signal lever of the vehicle is operated, and vehicle speed information of the vehicle, that, in a state in which the vehicle is capable of forward running, the brake pedal of the vehicle changes from an unpressed state to a pressed state and the turn signal lever is not operated, making a determination as to whether, within the set duration, the turn signal lever is operated and a maximum value of the vehicle speed of the vehicle is at least a first threshold value.

A program of the present disclosure may be a combination of configuration 9 described below and one or more of configurations 1 to 7.

<Configuration 9> A program that is executable by a computer to execute processing including, for a predetermined set duration from a first time at which it is determined, on the basis of brake operation information representing whether or not a brake pedal of a vehicle is pressed, lever operation information representing whether or not a turn signal lever of the vehicle is operated, and vehicle speed information of the vehicle, that, in a state in which the vehicle is capable of forward running, the brake pedal of the vehicle changes from an unpressed state to a pressed state and the turn signal lever is not operated, making a determination as to whether, within the set duration, the turn signal lever is operated and a maximum value of the vehicle speed of the vehicle is at least a first threshold value.

An object of the present disclosure is to provide a driving operation determiner, a driving operation determination system, a driving operation determination method and a memory medium memorizing a program that may determine whether operations of a turn signal lever and a brake pedal of a vehicle that turns right or left while running forward are operations with a risk of causing concern to a driver of a following vehicle.

A first aspect of the present disclosure is a driving operation determiner that includes: a memory; and a processor coupled to the memory, the processor being configured to: based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and determine whether, within a predetermined set duration of time from a first time at which the first specific condition is satisfied, the turn signal lever is operated and a maximum value of a vehicle speed of the vehicle is a first threshold value or greater.

The driving operation determiner according to the first aspect determines whether or not the brake pedal of a vehicle that is running forward at a certain level of speed is pressed before the turn signal lever is operated. If the brake pedal of a vehicle that is turning right or left while running forward at a significant speed is pressed before the turn signal lever is operated, there is a high probability that a driver of a vehicle following this vehicle will feel concern. Therefore, the first aspect may determine whether or not operations of the turn signal lever and brake pedal of the vehicle that turns right or left while running forward are operations with a risk of causing concern to a driver of a following vehicle.

A second aspect of the present disclosure is the driving operation determiner according to the first aspect, wherein the processor is configured to determine whether the vehicle speed at the first time is higher, by a second threshold value or greater, than the vehicle speed at a second time, the second time being an end time of the set duration of time.

The driving operation determiner according to the second aspect determines whether or not a brake operation that greatly reduces the vehicle speed is conducted in the vehicle within the set duration. Therefore, the second aspect may accurately determine whether or not operations of the turn signal lever and brake pedal of the vehicle that turns right or left while running forward are operations with a risk of causing concern to a driver of a following vehicle.

A third aspect of the present disclosure is the driving operation determiner according to the first or second aspect, wherein the processor is configured to, in a case in which a shift position of a shift lever of the vehicle changes from a first specified position to a forward travel position at which a gear for forward travel is formed, the first specified position being any of a P range, an R range or an N range, and the shift lever moving to the first specified position at a third time, exclude a time period preceding a fourth time from the set duration of time, the fourth time being a first predetermined duration of time after the third time.

According to the third aspect, when, for example, the vehicle is entering or leaving a parking space, there is a high probability of the shift position of the shift lever changing between the first specified position and the forward running position. Therefore, the third aspect provides a smaller risk of an erroneous determination that a vehicle that is, for example, entering or leaving a parking space is turning right or left.

A fourth aspect of the present disclosure is the driving operation determiner according to the first aspect, wherein the processor is configured to, in a case in which a shift position of a shift lever of the vehicle changes from a forward travel position at which a gear for forward travel is formed to a second specified position that is any of a P range, an R range or an N range, and the shift position subsequently changes from the second specified position to a different shift position, the shift lever moving to the different shift position at a sixth time, exclude a time period succeeding a fifth time from the set duration of time, the fifth time being a second predetermined duration of time before the sixth time.

The fourth aspect provides a smaller risk of an erroneous determination that a vehicle that is, for example, entering or leaving a parking space is turning right or left.

A fifth aspect of the present disclosure is the driving operation determiner according to the first or second aspect, wherein the processor is configured to: based on steering angle information representing a steering angle of a steering wheel of the vehicle, the lever operation information, and the vehicle speed information, determine whether a second specific condition is satisfied in the state in which the vehicle is capable of forward travel, the second specific condition being satisfied in a case in which an absolute value of the steering angle of the vehicle is a third threshold value or greater, the turn signal lever is not operated, and the vehicle speed is a fourth threshold value or greater; and, based on yaw angle information representing a yaw angle of the vehicle and the steering angle information while the second specific condition is satisfied, determine whether: an absolute value of the yaw angle is from a fifth threshold value to a sixth threshold value; and an absolute value of a maximum value of the steering angle is from a seventh threshold value to an eighth threshold value.

The fifth aspect may detect that a vehicle that is running forward turns right or left without the turn signal lever being operated.

A sixth aspect of the present disclosure is the driving operation determiner according to the fifth aspect, wherein the processor is configured to determine whether: a duration of time for which the second specific condition is satisfied continuously is a ninth threshold value or greater, and a maximum value of the vehicle speed while the second specific condition is satisfied is a tenth threshold value or lower.

The sixth aspect may accurately detect that a vehicle that is running forward turns right or left without the turn signal lever being operated.

A seventh aspect of the present disclosure is a driving operation determination system that includes: the driving operation determiner according to the first or second aspect; a brake switch that acquires the brake operation information; a turn signal switch that acquires the lever operation information; and a vehicle speed sensor that acquires the vehicle speed information.

An eighth aspect of the present disclosure is a driving operation determination method that includes: by a processor, based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and determine whether, within a predetermined set duration of time from a first time at which the first specific condition is satisfied, the turn signal lever is operated and a maximum value of a vehicle speed of the vehicle is a first threshold value or greater.

A ninth aspect of the present application is a non-transitory storage medium storing a program that is executable by a processor to execute processing that includes: based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and determine whether, within a predetermined set duration of time from a first time at which the first specific condition is satisfied, the turn signal lever is operated and a maximum value of a vehicle speed of the vehicle is a first threshold value or greater.

As described above, a driving operation determiner, driving operation determination system, driving operation determination method and memory medium memorizing a program according to the present disclosure may determine whether or not operations of a turn signal lever and a brake pedal of a vehicle that turns right or left while running forward are operations with a risk of causing concern to a driver of a following vehicle.

What is claimed is:

1. A driving operation determiner comprising:
a memory; and
a processor coupled to the memory, the processor being configured to:
based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and
determine whether, within a predetermined set duration of time from a first time at which the first specific condition is satisfied, the turn signal lever is operated and a maximum value of a vehicle speed of the vehicle is a first threshold value or greater.

2. The driving operation determiner according to claim 1, wherein the processor is configured to determine whether the vehicle speed at the first time is higher, by a second threshold value or greater, than the vehicle speed at a second time, the second time being an end time of the set duration of time.

3. The driving operation determiner according to claim 1, wherein the processor is configured to, in a case in which a shift position of a shift lever of the vehicle changes from a first specified position to a forward travel position at which a gear for forward travel is formed, the first specified position being any of a P range, an R range or an N range, and the shift lever moving to the first specified position at a third time,
exclude a time period preceding a fourth time from the set duration of time, the fourth time being a first predetermined duration of time after the third time.

4. The driving operation determiner according to claim 1, wherein the processor is configured to, in a case in which a shift position of a shift lever of the vehicle changes from a forward travel position at which a gear for forward travel is formed to a second specified position that is any of a P range, an R range or an N range, and the shift position subsequently changes from the second specified position to a different shift position, the shift lever moving to the different shift position at a sixth time,
exclude a time period succeeding a fifth time from the set duration of time, the fifth time being a second predetermined duration of time before the sixth time.

5. The driving operation determiner according to claim 1, wherein the processor is configured to:
based on steering angle information representing a steering angle of a steering wheel of the vehicle, the lever operation information, and the vehicle speed information, determine whether a second specific condition is satisfied in the state in which the vehicle is capable of forward travel, the second specific condition being satisfied in a case in which an absolute value of the steering angle of the vehicle is a third threshold value or greater, the turn signal lever is not operated, and the vehicle speed is a fourth threshold value or greater; and,
based on yaw angle information representing a yaw angle of the vehicle and the steering angle information while the second specific condition is satisfied, determine whether:
an absolute value of the yaw angle is from a fifth threshold value to a sixth threshold value; and
an absolute value of a maximum value of the steering angle is from a seventh threshold value to an eighth threshold value.

6. The driving operation determiner according to claim 5, wherein the processor is configured to determine whether:
a duration of time for which the second specific condition is satisfied continuously is a ninth threshold value or greater, and
a maximum value of the vehicle speed while the second specific condition is satisfied is a tenth threshold value or lower.

7. A driving operation determination system comprising:
the driving operation determiner according to claim 1;
a brake switch that acquires the brake operation information;
a turn signal switch that acquires the lever operation information; and
a vehicle speed sensor that acquires the vehicle speed information.

8. A driving operation determination method comprising:
by a processor,
based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and
determine whether, within a predetermined set duration of time from a first time at which the first specific condition is satisfied, the turn signal lever is operated and a maximum value of a vehicle speed of the vehicle is a first threshold value or greater.

9. A non-transitory storage medium storing a program that is executable by a processor to execute processing comprising:
based on brake operation information representing whether or not a brake pedal of a vehicle is pressed, lever operation information representing whether or not a turn signal lever of the vehicle is operated, and vehicle speed information of the vehicle, determine whether a first specific condition is satisfied, the first specific condition being satisfied in a case in which, in a state in which the vehicle is capable of forward travel, the brake pedal of the vehicle changes from an unpressed state to a pressed state and the turn signal lever is not operated; and
determine whether, within a predetermined set duration of time from a first time at which the first specific condition is satisfied, the turn signal lever is operated and a maximum value of a vehicle speed of the vehicle is a first threshold value or greater.
